(19) United States
(12) Patent Application Publication
(10) Pub. No.: US 2008/0072671 A1
(43) Pub. Date: Mar. 27, 2008

(54) Leveraged shear mode accelerometers

(76) Inventors: Eldon Eller, San Marcos, CA (US); Sarah Rhee, Pennsylvania Furnace, PA (US)

Correspondence Address: HELLER EHRMAN LLP, 275 MIDDLEFIELD ROAD, MENLO PARK, CA, 94025-3506, US

(21) Appl. No.: 11/535,364

(22) Filed: Sep. 26, 2006

(51) Int. Cl. G01P 15/09

(52) U.S. Cl. 73/514.34

(57) ABSTRACT

A single crystal based leveraged shear mode accelerometer includes a housing base portion with a base portion bottom surface that includes two base metallization areas. A housing top portion is coupled to the housing base portion. A subassembly includes a piezoelectric single crystal positioned between the housing base portion and the housing top portion. The piezoelectric single crystal is held vertical by the base portion and a shear plate bonded with a metal loaded electrical conductive epoxy. The base portion and the shear plate both have machined edges in a vertical direction. These machined edges pointing against an electrically insulating plate and form an active electrical connection at a top surface of the piezoelectric single crystal, and an electrical ground connection at a bottom surface of the piezoelectric single crystal. The subassembly is held to a mass construct with micromachined screws to the base portion, forming an accelerometer assembly in tension.

### BACKGROUND OF THE INVENTION

1. Field of the Invention

This invention relates generally to leveraged shear mode accelerometers, and their methods of use, and more particularly to leveraged shear mode accelerometers, and their methods of use, that have a piezoelectric single crystal.

2. Description of the Related Art

It is known to use piezoelectric accelerometers for measuring the vibrations. Among the known basic principles used for the design of accelerometers, there are two that are the most frequently used, namely, the shear mode design and the compression mode design. The compression mode designs can be split in two subgroups. A first subgroup using a pure compression of a monolithic stack of one or more piezoelectric elements with a coupled seismic mass (d ₃₃ mode) in the z-axis whereas a second subgroup uses a bending mode element (d ₃₁). These two basic designs use none or one seismic mass which, under the effect of an applied force generated by the vibrations, act upon one or more piezoelectric elements.

Each one of these two basic accelerometer designs has advantages and disadvantages for the design including the packaging, functionality, and size. The usage of shear mode piezoelectric elements offers the significant advantage of suppressing the temperature-induced pyroeffect by using a different sensitive axis than (d ₃₃). Hence the temperature-dependent output is less altered by the pyroeffect which can significantly change the output of the accelerometer when exposed to operating temperature changes.

There is a need for a piezoceramic shear mode accelerometer which is small, rugged, light weight, virtually temperature-independent, and high voltage/charge output. There is a further need for a piezoceramic shear mode accelerometer that allows for surface mounting, requires no lead wires for electrical connection to the ASIC or circuit board and exhibits high signal output upon applied vibration force.

### SUMMARY

An object of the present invention is to provide an improved leveraged shear mode accelerometer, and its associated methods of use.

Another object of the present invention is to provide a leveraged shear mode accelerometer, and its methods of use, that is small, rugged, light weight, and with high output performance.

A further object of the present invention is to provide a leveraged shear mode accelerometer, and its methods of use, that is a single crystal based accelerometer.

Still another object of the present invention is to provide a leveraged shear mode accelerometer, and its methods of use that has a shear mode (d ₁₅) relaxor single crystal as the sensing element.

Another object of the present invention is to provide a shear mode accelerometer, and its methods of use that has a piezoelectric crystal, poled along perpendicular to the sensing axis of the element.

Yet a further object of the present invention is to provide a shear mode accelerometer, and its methods of use that has a PMN-PT or PZN-PT crystal, poled perpendicular to the sensing axis of the element and therefore is less sensitive to the temperature-induced pyroelectric effect.

These and other objects of the present invention are achieved in a single crystal based leveraged shear mode accelerometer. A housing base portion has a base portion bottom surface that includes two base metallization areas. A housing top portion is coupled to the housing base portion. A subassembly includes a piezoelectric single crystal positioned between the housing base portion and the housing top portion. The piezoelectric single crystal is held vertical by the base portion and a shear plate bonded with a metal loaded electrical conductive epoxy. The base portion and the shear plate both have machined edges in a vertical direction. These machined edges pointing against an electrically insulating plate and form an active electrical connection at a top surface of the piezoelectric single crystal, and an electrical ground connection at a bottom surface of the piezoelectric single crystal. The subassembly is held to a mass construct with micromachined screws to the base portion, forming an accelerometer assembly in tension.

In another embodiment of the present invention, a method is provided for measuring vibration includes providing a vibration measuring device. The vibration measuring device has a single crystal based leveraged shear mode accelerometer that includes a sub-assembly with a piezoelectric single crystal positioned between a housing base portion and a housing top portion. The piezoelectric single crystal is held vertical by the base portion and a shear plate bonded with a metal loaded electrical conductive epoxy. The housing base portion and the shear plate both have edges in a vertical direction that point against an electrically insulating plate and form an active electrical connection at a top surface of the piezoelectric single crystal, and an electrical ground connection at a bottom surface of the piezoelectric single crystal. The subassembly is held to a mass construct with micromachined screws to the base portion forming an accelerometer assembly in tension. The vibration measuring device is in a position to measure vibration at a selected site. The vibration measuring device is utilized to measure vibration at the selected site.

### DESCRIPTION OF THE FIGURES

FIGS. 1(a) through 1(c) are schematic diagrams of one embodiment of a leveraged shear mode accelerometer of the present invention.

### DETAILED DESCRIPTION

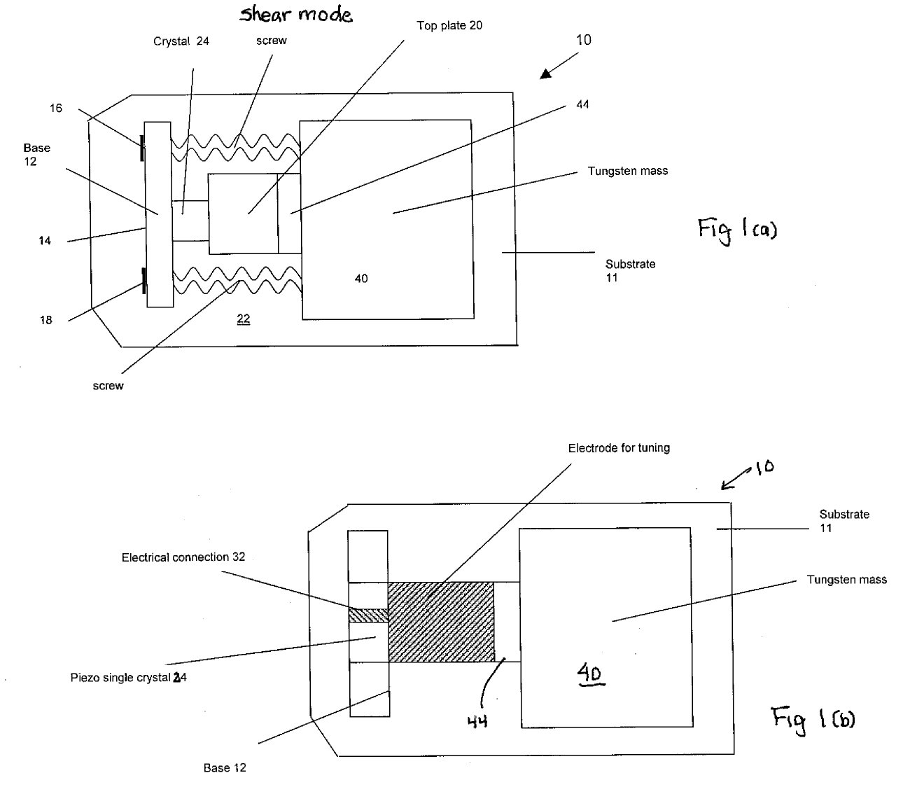

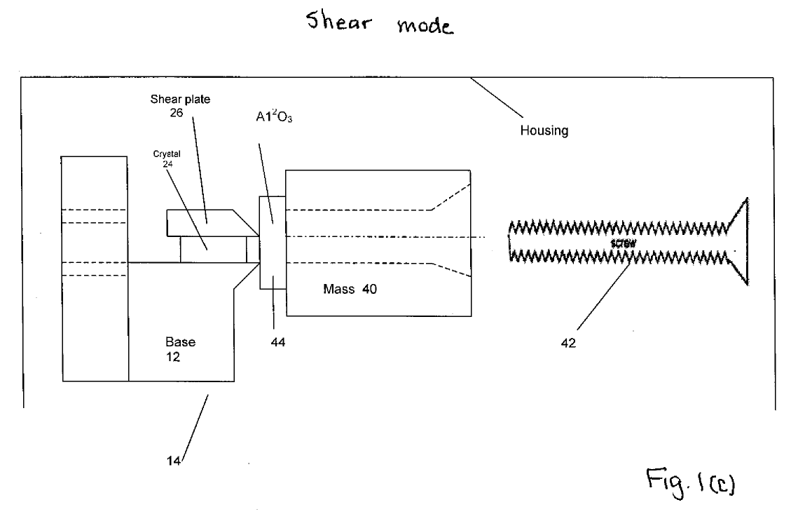

Referring to FIGS. 1(a)-(c), one embodiment of the present invention is a single crystal based leveraged shear mode accelerometer 10. A housing base portion 12 has a base portion bottom surface 14 that includes two base metallization areas 16 and 18, respectively. In one embodiment, the housing base portion 12 is formed of metallized ceramic.

A housing top portion 20 is coupled to the housing base portion 12. A subassembly, generally denoted as 22, includes a piezoelectric single crystal positioned 24 between the housing base portion 12 and the housing top portion 20. The piezoelectric single crystal 24 is held vertical by the housing base portion 12 and a shear plate 26 that can be bonded with a metal loaded electrical conductive epoxy 28. The piezoelectric single crystal 24 can be a shear mode (d 15) relaxor single crystal. In various embodiments, the piezoelectric single crystal 24 is a PMN-PT (lead metaniobate—lead titanate) or PZN-PT (lead zinc niobate—lead titanate) crystal, electroded and poled in <100> direction with electrodes removed and reapplied in a perpendicular direction. In one embodiment, the piezoelectric single crystal 24 senses mechanical vibration in a z-axial direction.

The housing base portion 12 and the shear plate 26 both have machined edges 28 in a vertical direction. The machined edges 28 point against an electrically insulating plate 30 and form an active electrical connection 32 at a top surface 34 of the piezoelectric single crystal, and an electrical ground connection 36 at a bottom surface 38 of the piezoelectric single crystal. The subassembly 22 can be held to a two-piece tungsten mass construct 40 with micromachined screws 42 to the housing base portion 12, forming an accelerometer assembly in tension. In one embodiment, the accelerometer assembly in tension is formed without epoxy flue lines.

In one embodiment, the mass construct 40 is a two-piece tungsten mass construct. In one embodiment, the housing base portion 12, the piezoelectric single crystal 24 crystal and the shear plate 26 are held to the mass construct 40 with the micromachined screws 42 in tension. In another embodiment, the mass construct 40 is made of micromachined tungsten with threads and two fitted screws. The mass construct 40 can be isolated from the subassembly 22 by an electrically insulating ceramic plate 44.

In one embodiment, the piezoelectric single crystal 24 senses mechanical vibration in the 50 to 120 Hz range in a z-axialdirection.

The base portion 12 can be formed of a metallized ceramic. It will be appreciated that the accelerometer 10 can have different geometric configurations. In one embodiment, the accelerometer 10 is a rectangular prismatic structure.

In one embodiment, the accelerometer has a high voltage output. The high voltage output can be greater than 200 mV/g).The accelerometer 10 can be included in a vibration measuring device that measures vibration. Suitable vibration measuring devices include but are not limited to, a cardiac rhythm management device, a cardiac monitoring device a neurostimulation device, a neurosignal generating device, interruption or blocking device, a clamp style ablation device, an internal catheter based ablation device, an external or internal measuring device for blunt force trauma to the body, a device for measuring external forces on the head mounted internally or externally, a body motion tilt sensing device, a device for measuring vibration, forces on, and movement of prosthetic limbs, and the like.

In one embodiment, the accelerometer 10 is configured to measure vibration at a frequency under resonance. In one embodiment, the accelerometer is configured to measure vibration in a range of 100 Hz to 2,500 Hz. When the vibration measuring device is a cardiac rhythm management device, the accelerometer 10 measures vibration of 20 to 200 Hz.

In one embodiment of a method of the present invention, the vibration measuring device is placed in a position to measure vibration at a selected site. Different types of sites can include, but are not limited to, the torso body cavity, the chest cavity inhabited by the heart, the back cavity inhabited by the spinal cord, the torso body cavities that are inhabited by organs that may require or be receptive to drug therapies, the ear canal, the external torso area, and external limb sites including the arms and legs, and the like. The accelerometer 10 measures vibration at the selected site.

The accelerometer 10 can be adhesively secured and electrically connected to pads on an ASIC substrate 46 by a conductive epoxy and structural epoxy between the pads and the metallization areas 16 and 18. When acceleration is applied to the ASIC substrate 11 along a vector perpendicular thereto, the piezoelectric single crystal 24 flexes in response to the acceleration force.

The accelerometer 10 can have a low capacitance. As can easily be appreciated, the piezoelectric single crystal 24 provides electrical charge in response to stressing of the piezoceramic portions thereof. In one embodiment, the accelerometer 10 has an internal capacitance of about 50 pF, with a charge sensitivity to acceleration along the principle is of 200 mV/G. This combination of charge sensitivity and low internal capacitance results in an electrical output from the accelerometer 10 which is easily accommodated by measurement circuitry external to the accelerometer 10.

### EXAMPLE 1

In this example, the leveraged shear mode based accelerometer 10 is included in a cardiac rhythm management device. The piezoelectric single crystal 24 is a shear mode (d ₁₅) relaxor single crystal. The cardiac rhythm management device is designed to deliver an electrical signal to the heart muscle to regulate and control the heart beat rate. Certain inherent physical conditions, external conditions, and physical activities can cause the heart to beat at a rate lower than desired, as well as at a rate higher than desired. The single crystal leveraged shear mode based accelerometer 10 is capable of sensing the heart beat rate, and provides an electrical signal to the cardiac rhythm management device proportional to the heart beat rate. The cardiac rhythm management device uses this information to adjust its output to the heart muscle to correctly regulate or maintain the desire heart beat rate. Information from the single crystal leveraged shear mode based accelerometer 10 can also be used for these devices.

The leveraged shear mode based accelerometer 10 is mounted inside of a hermetically sealed enclosure of typically titanium material that houses the other components, battery, printed circuit boards, electrical lead connections, software storage devices, and operational logic devices that comprise a complete cardiac rhythm management device.

### EXAMPLE 2

In this example, the single crystal based accelerometer 10 is used to measure vibration at a frequency under resonance. Vibration is measured in the range of 100-2,500 Hz.

The foregoing description of embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A single crystal based leveraged shear mode accelerometer, comprising:
a housing base portion with a base portion bottom surface that includes two base metallization areas;
a housing top portion coupled to the housing base portion; and
a subassembly that includes a piezoelectric single crystal positioned between the housing base portion and the housing top portion, the piezoelectric single crystal being held vertical by the base portion and a shear plate bonded with a metal loaded electrical conductive epoxy, the base portion and the shear plate both having machined edges in a vertical direction pointing against an electrically insulating plate and form an active electrical connection at a top surface of the piezoelectric single crystal and an electrical ground connection at a bottom surface of the piezoelectric single crystal, the subassembly being held to a mass construct with micromachined screws to the base portion forming an accelerometer assembly in tension.

2. The accelerometer of claim 1, wherein the mass construct is a two-piece tungsten construct.

3. The accelerometer of claim 1, wherein the housing base portion, crystal and shear plate assembly are held to the mass construct with the micromachined screws in tension.

4. The accelerometer of claim 1, wherein the mass construct is made of micromachined tungsten with threads and two fitted screws.

5. The accelerometer of claim 1, wherein the mass construct is isolated from the subassembly by an electrically insulating ceramic plate.

6. The accelerometer of claim 1, wherein the accelerometer assembly in tension is formed without epoxy flue lines.

7. The accelerometer of claim 1, wherein the piezoelectric single crystal is a shear mode (d ₁₅) relaxor single crystal.

8. The accelerometer of claim 1, wherein the piezoelectric single crystal is a PMN-PT (lead metaniobate—lead titanate) or PZN-PT (lead zinc niobate—lead titanate) crystal, electroded and poled in <100>direction, with electrodes removed and reapplied in perpendicular direction.

9. The accelerometer of claim 1, wherein the piezoelectric single crystals senses mechanical vibration in a z-axial direction.

10. The accelerometer of claim 1, wherein the base portion is formed of metallized ceramic.

11. The accelerometer of claim 1, wherein the accelerometer is a rectangular prismatic structure poled in perpendicular direction to the electrodes.

12. The accelerometer of claim 1, wherein the accelerometer has a high voltage output.

13. The accelerometer of claim 1, wherein the accelerometer has a high voltage output of greater than 200 mV/g.

14. The accelerometer of claim 1, wherein the accelerometer is included in a device that measures vibration.

15. The accelerometer of claim 1, wherein the accelerometer is configured to measure vibration at a frequency under resonance.

16. The accelerometer of claim 1, wherein the accelerometer is configured to measure vibration in a range of 100 Hz to 2,500 Hz.

17. The accelerometer of claim 1, wherein the accelerometer is included in a cardiac rhythm management device.

18. The accelerometer of claim 17, wherein the accelerometer is configured to measure vibration of about 200 Hz.

19. The accelerometer of claim 1, wherein the accelerometer is included in a cardiac monitoring device.

20. A method of measuring vibration, comprising:
providing a vibration measuring device with a single crystal based leveraged shear mode accelerometer that includes a sub-assembly with a piezoelectric single crystal positioned between a housing base portion and a housing top portion, the piezoelectric single crystal being held vertical by the base portion and a shear plate bonded with a metal loaded electrical conductive epoxy, the housing base portion and the shear plate both having edges in a vertical direction that points against an electrically insulating plate and form an active electrical connection at a top surface of the piezoelectric single crystal and an electrical ground connection at a bottom surface of the piezoelectric single crystal, the subassembly being held to a two-piece tungsten mass construct with micromachined screws to the base portion forming an accelerometer assembly in tension.
positioning the vibration measuring device in a position to measure vibration at a selected site; and
utilizing the vibration measuring device to measure vibration at the selected site.

21. The method of claim 20, wherein the vibration is measured at a frequency under resonance.

22. The method of claim 20, wherein the vibration is measured in a range of 100 Hz to 2,500 Hz.

23. The method of claim 20, wherein the vibration is measured in a range of 20 to 160 Hz range in a z-axial direction.

24. The method of claim 20, wherein the vibration measuring device is included in a cardiac rhythm management device.

25. The method of claim 20, wherein the selected site is a human chest cavity.

26. The accelerometer of claim 24, wherein the accelerometer is configured to measure vibration of about 200 Hz.

27. The method of claim 20, wherein the piezoelectric single crystal is a compression mode (d ₃₁) relaxor single crystal.

28. The method of claim 20, wherein the piezoelectric single crystal is a piezoelectric crystal, poled along <110>.

29. The method of claim 20, wherein the piezoelectric single crystal is a PMN-PT or PZN-PT crystal, poled along <110> to optimize the highest (d ₃₁) piezoelectric output.
